(19) United States
(12) Patent Application Publication
(10) Pub. No.: US 2002/0178073 A1
(43) Pub. Date: Nov. 28, 2002

(54) AVI for expedited mobile ordering and fulfillment

(76) Inventor: Kelly Gravelle, San Diego, CA (US)

Correspondence Address: BLANK ROME COMISKY & MCCAULEY, LLP, 900 17TH STREET, N.W., SUITE 1000, WASHINGTON, DC, 20006, US

(21) Appl. No.: 09/864,443

(22) Filed: May 25, 2001

(51) Int. Cl. H04Q 5/22; G06F 17/60

(52) U.S. Cl. 705/26; 340/10.1

(57) ABSTRACT

The disclosed order fulfillment method includes the steps of placing an order for an item by specifying the item, location for picking up the item, expected time of item pick up, and an account number; relaying the order to a validating processor; identifying an AVI transponder with the account number provided by a customer; and authorizing the AVI transponder to pay for the order. The method further comprises including the order in a list of orders sorted according to the expected pick up time and the item preparation time; displaying the list of orders to personnel preparing the order; reading information from the AVI transponder when the transponder arrives at the pick up location; identifying items prepared that correspond to the transponder; and delivering the prepared items to the customer.

### BACKGROUND OF THE INVENTION

1. Field of the Invention

The present invention relates to automated vehicle identification (AVI) systems, and more particularly, to the use of AVI systems in conjunction with wireless, voice or data communication for expedited mobile ordering and fulfillment.

2. Description of the Prior Art

It is well understood in the art that mobile commerce can involve the use of cellular telephones and Internet technologies to facilitate transactions such as consumer orders for goods. Nevertheless, as with Internet ordering, the more difficult problem lies in the development of efficient approaches for the fulfillment of these orders.

Problems associated with the prior art include the delay in the delivery of orders due to outdated order management systems and also due to manual entry of order confirmation numbers, etc. While businesses such as quick service restaurants (QSRs) have taken advantage of the drive-through concept to fulfill orders, at the present time there is no known combination of the drive through concept with wireless and Internet technologies. Therefore, there is a need in the art to improve the existing order fulfillment processes.

### SUMMARY AND OBJECTS OF THE INVENTION

Systems and methods of the present invention combine the use of mobile and/or Internet ordering with the use of an AVI transponder affixed to a vehicle in a drive through lane at a designated point for picking up the goods or merchandise that have been ordered.

More specifically, the method includes the steps of placing an order for an item by specifying the item, location for picking up the item, expected time of item pick up, and an identification; relaying the order to a validating processor; identifying a wireless tag identification number corresponding to the provided identification; and authorizing payment of the order from an account associated with the wireless tag.

The method further consists of including the order in a list of orders sorted according to expected pick up time and item preparation time; displaying the list of orders in an area where the order is prepared before pick up; reading information from the wireless tag when the tag is located in a vicinity of the pick up location; and identifying items prepared that correspond to the wireless tag.

It is an object of the present invention to improve the efficiency of the existing order fulfillment processes. Another object of the present invention is to deliver items to a customer right after the items have been prepared. Still another object of the present invention is to take into account the expected arrival time of a customer with the item preparation time in order to achieve the aforementioned objects.

With these and other objects, advantages and features of the invention that may become hereinafter apparent, the nature of the invention may be more clearly understood by reference to the following detailed description of the invention, the appended claims and to the accompanying drawings.

### BRIEF DESCRIPTION OF THE DRAWINGS

The preferred embodiments of this invention will be described in detail, with reference to the following figures, wherein:

FIG. 1 is a diagram showing the fulfillment system of the present invention; and

FIG. 2 is a diagram showing an alternate embodiment of the fulfillment system of the present invention.

### DETAILED DESCRIPTION OF THE PREFERRED EMBODIMENTS

In the present system, customers have an AVI transponder for use with the system. Customers also have a pre-paid account that contains a balance. The pre-paid account is associated with the use of the AVI transponder and is also associated with a credit or debt card. When the balance in the pre-paid account drops below a certain specified level, which can vary, the account can be replenished by charging the credit or debit account through a pre-authorized debit. The present system also supports the ability to directly charge the credit card or bank account for the completion of transactions, instead of charging the pre-paid customer account.

The method of the present invention starts with a telephone call placed by a customer into a central service center. An operator taking the order will ask the customer for identification and perhaps for some corroborating data. The customer will also be asked about the location for picking up the order and about the approximate time it will take the customer to arrive at the pick-up location.

Since the validity of an account number associated with the identification provided by the customer can be confirmed by the operator, payment to the merchant can be guaranteed by the operator, so there is no risk to the merchant, for example a restaurant owner, in accepting the order. The order is then transmitted over the Internet to a local server or display in the restaurant, and then proceeds to be queued for display to the cooking staff. The system may be configured to provide for the correct cooking time for each ordered item, for example, 5 minutes for a hamburger. The system thus presents the order to the staff as well as the correct time before the driver's anticipated arrival. The ordered item may then be cooked, bagged and ready to deliver to the customer just in time.

Upon arrival at the drive-thru pick up location, the customer approaches the order board and the vehicle transponder is read. The order associated with the read transponder is looked up in the local server memory and is displayed to the driver. A worker asks to confirm that the order is correct, or if the customer wishes to make changes. The driver then proceeds to pick up his order, which is ready and waiting to be picked up. The transponder is read again to localize the car at the order window and to ensure the order is being fulfilled to the proper vehicle/account.

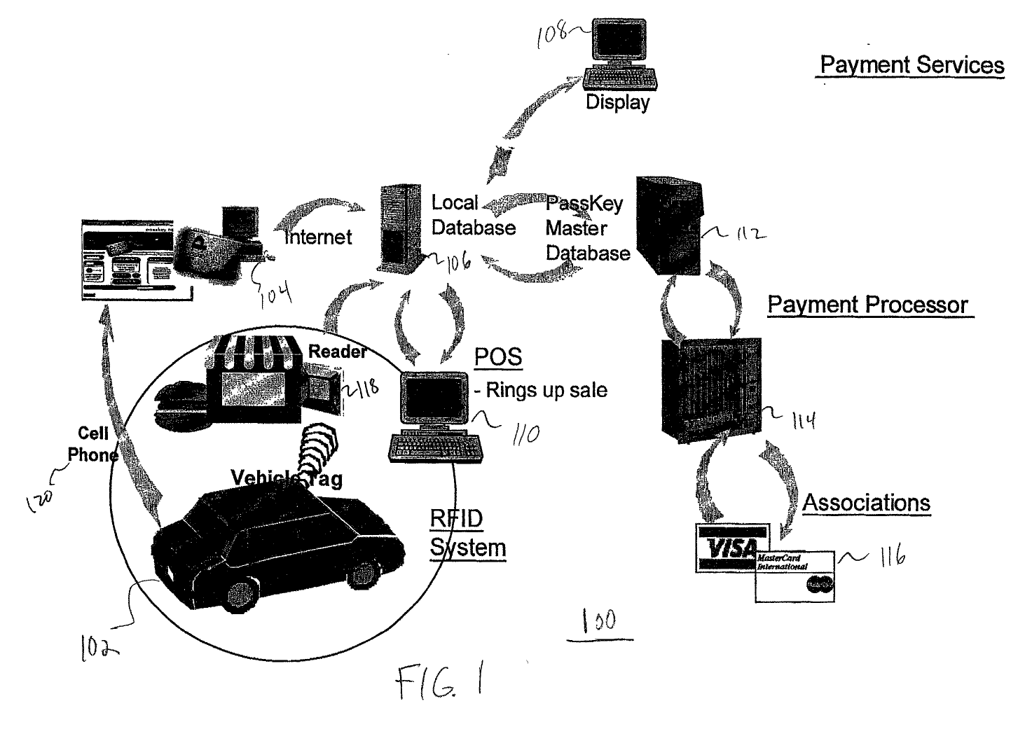

FIG. 1 shows a first embodiment 100 of the system of the present invention. The system includes a vehicle with an AVI transponder (transponder 102); and transponder reader (reader 118); a cellular telephone 120; an operator for receiving orders (operator 104); a local database 106; a point of sale terminal (POS 110); a display 108; a database 112; a payment processor 114; and a source of electronic funds 116.

The transponder 102 mounted on the vehicle may be a radio frequency identification (RFID) tag, which is interrogated by the reader 118. Upon interrogating the transponder 102, the reader 118 obtains the identification number of the transponder 102.

The cellular telephone 120 is used in the system 100 to place an order. The operator 104 may be a human operator that receives orders from the cellular telephone 120 (or via conventional telephone), and enters the order information in a computer. Alternatively the operator 104 may be a computer programmed to automatically accept orders via the Internet.

The local database 106 may be a conventional database system running on a personal computer located at the place where the order is entered into the system. It can thus be local to the merchant store or can be located in the central offices for a chain of merchants. The POS 110 may be located at the item pick up location.

The display 108 may be a conventional monitor used for displaying data provided by a database. The display may be located where the items ordered are being prepared for delivery.

The database 112 may be a conventional database used for, among other things, storing identification numbers of the transponders in the system. The payment processor 114 processes data in the database 112 and communicates with the source of electronic funds (credit card 116). The processor 114 may be a conventional personal or mainframe computer. The source of electronic funds may be a credit card account, debit card account, or a banking account.

In the following example, it is assumed that the customer has a prepaid balance of $10.00 in his account (the customer account). The customer places a $20.00 order via the cellular telephone 120. The order is entered by the operator 104 and includes a description of the items ordered as well as an estimate of the time it will take the customer to arrive at the pick up location. Further, the order information should include identification information such as the customer account number, the customer's telephone number, a personal identification number, or the customer name.

The order information is relayed to the local database 106 via a communication channel such as an Internet connection. The display 108 accesses the order information from the database 106 and displays the information to personnel preparing the ordered items for pick up. The database 106 may sort received orders according to the estimated item preparation time and to the pick up time specified by the customers. The display 108 may in turn display a list of the orders sorted as described above.

The local database 106 requests the database 112 to validate the transponder for an amount of $20.00. The database 112 then searches for subscriber account information based on the identification information supplied by the customer when submitting the order (e.g., customer name, subscriber account information, etc.) Although the subscriber account only has a prepaid balance of $10.00 and the value of the order is $20.00, the database 112 may validate the transponder if the customer has previously authorized the transfer of funds from another account (e.g., credit card) into the customer account. The database 112 then validates the transponder and sends a notification of such validation to the local database 106.

Further, the payment processor 114 acts upon the overcharge of the subscriber account by charging at least the difference between the prepaid balance and the order value to the customer's credit card 116.

When the vehicle with the transponder 102 approaches the pick up location, the reader 118 interrogates the transponder 102 and then reads information from it. That information may include, for example, a transponder identification number, which is then relayed to the local database 106. The local database 106 searches for a match between stored orders and the information read from the transponder.

The local database 106 correlates the read information with a record of validated transponders in order to find which order corresponds to the transponder just read. When the order is found, the local database 106 may then enable the POS 110 to finalize the transaction. The customer may then pick up the ordered items without any delay.

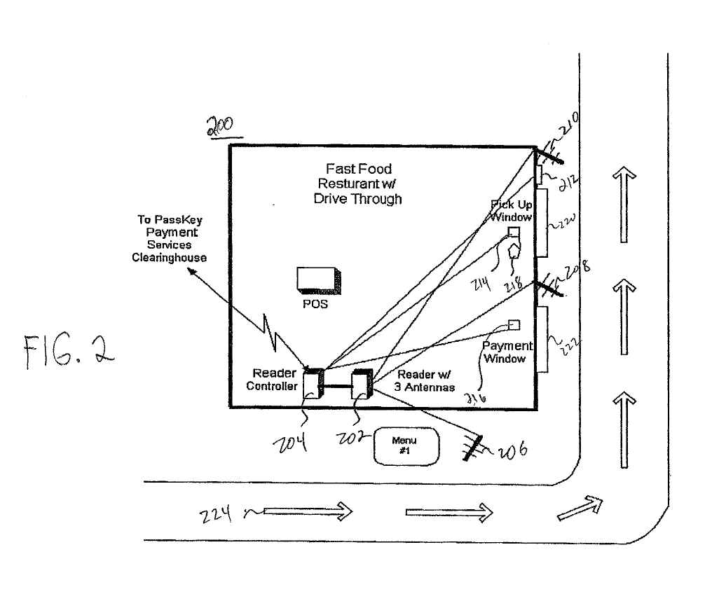

FIG. 2 illustrates a second embodiment 200 of the system of the present invention. The system 200 includes a reader 202; a reader controller 204; antennas 206, 208, and 210; a pick up window 220; a payment window 222; data entry terminals 214 and 216; printer 218; and display 212.

The reader 202 may be an RFID tag reader for interrogating and reading the transponder mounted on the vehicle (102 in FIG. 1) as the vehicle drives thru the lane marked with arrows 224. The antennas 206, 208, and 210 are connected to the reader 202 and are located at three different positions in order to detect the presence of the transponder at different stages of the payment process. Namely, vehicle arrival, payment, and pick up. The use of the antennas may include the detection through antenna 206 that the next customer in the drive-thru lane does not have a transponder. The controller 204 would then not direct the reader 202 to interrogate that customer vehicle.

The pick up window 220 is simply where the items ordered may be picked up by the customer. The payment window 222 is where the customer may get a corroboration that the transponder card has been properly detected through one of the antennas and has also been validated. The data entry terminal 216 may be operated by an attendant at the payment window 222 in order to solve any difficulties with the validation of the transponder. In the alternative, the data terminal 216 may be used to accept cash or debit/credit card payments from those customers that do not have a transponder mounted on their vehicles. In essence, the data terminal 216 may be described as the POS 110 of FIG. 1

The pick up window 220 is where the customer picks up the ordered items. The data entry terminal 214 may be used in connection with a printer 218 to complete the order (e.g., verify and enter data indicating that the order has been delivered) and to print a receipt of the transaction. Likewise, the display 212 displays the amount paid by the customer for final verification by the customer.

The controller 204 may be any processor programmed to control and coordinate the operation of the reader 202, the display 212, and the data terminals 214 and 216. That operation is described above. The controller 204 also receives and sends order information as described above with regard to the local database 106 in FIG. 1

There are many advantages to the present invention over the prior art. Using AVI to facilitate a cashless transaction in a drive thru lane does not solve the problem of long lines in e a drive-thru. For example, the mere use of AVI by itself does nothing to speed up the lengthiest part of the process, which is the cooking time. By permitting advance ordering, the above process allows considerably faster service. It also allows for higher quality food, as it provides the time to cook fresh food (as opposed to precooked), and to deliver it just in time when the food quality is at its maximum.

Further, the process also improves operator efficiency. Since operators get a considerably earlier notice of an order, it becomes easier to plan and control staff loading and resource allocation. For example, employee breaks might be re-alligned to avoid peak periods. Staff can be allocated where and when the need is greatest.

The ordering process discussed above may be executed by using any type of wireless voice or data communication. Likewise, the order may be placed via the Internet. That is, the system discussed above may accept orders for food or other items over the Internet for fulfillment at drive-through locations. For example, food orders could be placed at a traditional computer terminal or over a wireless personal digital assistant via e-mail or at an e-commerce web site, with essentially the same process described above. Nevertheless, fulfillment is still completed using the AVI transponder to identify the customer at the point of fulfillment. In addition, any type of private network can be used in lieu of the Internet to provide connectivity into the stores if desirable.

Further, the approach discussed above may also be used for more general applications than traditional fast food drive-thru fulfillment. For example, it would be possible for large retailers to install drive thru lanes for the fulfillment of Internet of e-commerce orders of merchandise, using an RFID transponder as the index of vehicles. The RFHD transponder provides rapid, efficient, and secure identification of the proper vehicle associated with the account.

In addition, the invention allows for a general fulfillment service. This service is a dedicated drive-thru operation. Users can place Internet orders at any time for a variety of goods, while designating that they should be picked up at a specific fulfillment center. Orders can then be efficiently routed by merchants to the specified fulfillment center, where the customer conveniently collects the ordered merchandise in the drive-thru. Once again, the properties of AVI using RF tags are utilized to queue, securely identify, and localize the vehicle and associate it with the proper account and order. In cases where relatively high value merchandise or large size orders may be fulfilled, the site can also make use of video audit and surveillance technologies. Such technologies are well known in the toll collection industry for the audit of toll transactions, for example. This allows the merchant/operator to re-construct the scene/image of the actual fulfillment in the case where it may be necessary to adjudicate a dispute.

While this invention has been described in conjunction with the specific embodiments outlined above, it is evident that many alternatives, modifications and variations are apparent to those skilled in the art. Accordingly, the preferred embodiments of the invention as set forth above are intended to be illustrative and not limiting. Various changes may be made without departing from the spirit and scope of the invention.

What is claimed is:

1. An ordering method comprising:
placing an order for an item by specifying the item and a location for picking up the item, and by providing an identification;
relaying the order to a validating processor;
identifying a wireless tag identification number corresponding to the identification provided;
authorizing payment of the order from an account associated with the wireless tag; and
reading the tag identification number from the wireless tag when the tag is located in a vicinity of the pick up location.

2. The method of claim 1, further comprising:
including the order in a list of orders sorted according to expected pick up time and item preparation time.

3. The method of claim 2, further comprising:
displaying the list of orders in an area where the order is prepared before pick up.

4. The method of claim 1, further comprising:
identifying items prepared that correspond to the wireless tag.

5. The method of claim 1, wherein the step of placing an order further comprises:
providing an expected time for pick up.

6. The method of claim 1, wherein providing an identification comprises providing a telephone number.

7. The method of claim 1, wherein providing an identification comprises providing a personal identification number.

8. The method of claim 1, wherein the account is a pre-paid account containing a balance.

9. The method of claim 1, wherein the account is a credit card account.

10. The method of claim 1, wherein the account is a check card account.

11. The method of claim 1, wherein the step of relaying comprises relaying the order to the validating processor via Internet.

12. The method of claim 1, wherein the step of placing the order comprises placing said order over a telephone.

13. The method of claim 1, wherein the step of placing the order comprises placing said order via Internet.

14. The method of claim 4, further comprising:
displaying the identified items to a carrier of the tag.

15. The method of claim 1, further comprising:
authorizing payment of the order in the event that the account associated with the wireless tag has insufficient funds; and
charging at least the difference between the available funds in said account and a purchase price to a secondary account.

16. The method of claim 4, wherein the step of identifying items comprises correlating the read tag identification number with a record of validated tags.

17. An ordering system comprising:
means for placing an order for an item, the order including the item, a location for picking up the item, and an identification;
a communication channel for relaying the order to a validating processor;
means for identifying a wireless tag identification number corresponding to the identification provided;
means for authorizing payment of the order from an account associated with the wireless tag; and
means for reading the tag identification number from the wireless tag when the tag is located in a vicinity of the pick up location.

18. The system of claim 17, further comprising:
a unit for displaying a list of orders, including said order, sorted according to expected pick up time and item preparation time.

19. The system of claim 17, further comprising:
means for identifying prepared items that correspond to the wireless tag.

20. The system of claim 17, wherein the order further includes an expected time for pick up.

21. The system of claim 17, wherein the identification comprises a telephone number.

22. The system of claim 17, wherein the identification comprises a personal identification number.

23. The system of claim 17, wherein the account is a pre-paid account containing a balance.

24. The system of claim 17, wherein the account is a credit card account.

25. The system of claim 17, wherein the account is a check card account.

26. The system of claim 17, wherein the communication channel comprises the Internet.

27. The system of claim 17, wherein the means for placing the order comprises a telephone.

28. The system of claim 17, wherein the means for placing the order comprises a computer network.

29. The system of claim 19, further comprising:
an unit for displaying the identified items to a carrier of the tag.

30. The system of claim 17, further comprising:
means for authorizing payment of the order in the event that the account associated with the wireless tag has insufficient funds; and
means for charging at least the difference between the available funds in said account and a purchase price to a secondary account.

31. The system of claim 19, wherein the means for identifying items comprises means for correlating the read tag identification number with a record of validated tags.
